(19) United States
(12) Patent Application Publication
(10) Pub. No.: US 2011/0080728 A1
(43) Pub. Date: Apr. 7, 2011

(54) LIGHT EMITTING DEVICE

(75) Inventors: Atsuji NAKAGAWA, Himeji-shi (Hyogo) (JP); Tomihiko IKEDA, Himeji-shi (Hyogo) (JP); Kana WATANABE, Himeji-shi (Hyogo) (JP)

(73) Assignee: PHOENIX ELECTRIC CO., LTD., Himeji-shi (Hyogo) (JP)

(21) Appl. No.: 12/785,032

(22) Filed: May 21, 2010

(30) Foreign Application Priority Data
Oct. 7, 2009 (JP) 2009-233262

(51) Int. Cl. F21V 1/00

(52) U.S. Cl. 362/235

(57) ABSTRACT

A light emitting device 10A comprises: a bowl-shaped reflector 12 having a focal point F; and illuminators 14 have LED elements 28 being square in planar view and lenses 30 forming virtual images I of the LED elements 28 behind the LED element 28; wherein a position of each of the virtual images I from the lens 30 is farther than a position of the focal point F from the lens 30; when a distance A between the virtual image I and the focal point F and a length of outer circumference B of the LED element 28 being square in planar view are assumed, a value of A divide B (A/B) is not less than 0.08 and not more than 0.42.

### BACKGROUND OF THE INVENTION

1. Field of the Invention

The present invention relates to a light emitting device used for a light source for general lighting at home, commercial facility, and exhibition facility, for example, or optical instrument.

2. Description of the Related Art

A light-emitting diode “LED”, which has good points such as low power consumption and long operating life as against a past incandescent lamp, for example a halogen lamp, is widely used, because people become more ecology conscious. And people consider that using the LED is one policy for the energy-saving strategies. Particularly, it is highly required to use the LED as an alternate item of the incandescent lamp.

In contrast, the LED has a problem that its amount of light is lower than amount of light of the incandescent lamp. Accordingly, a light emitting device which can emit much light with several LEDs has been developed to cover this problem (See Patent Document 1: Japanese Laid-Open Patent Publication No. 2005-123068).

As shown in FIG. 6, the light emitting device described in the Patent Document 1 comprises a reflector 3 having a reflecting surface 2 with a focal point F inside; and several illuminators 4 arranged inside of the reflector 3 in a radial manner with a central focus on the focal point F. Each illuminator 4 comprises a LED element 5 radiating light to the reflecting surface 2 and a lens 6 arranged between the LED element 5 and the reflecting surface 2. The lens 6 refracts the light radiated from the LED element 5 to the reflecting surface 2, and forms a virtual image I of the LED element 5 with a central focus on the focal point F that arranged behind the LED element 5.

According to this light emitting device 1, each of centers of the virtual images I (formed by the lenses 6) of the LED elements 5 is designed to be set on the focal point F of the reflecting surface 2. Consequently, all light radiated from the LED elements 5 and refracted with the lenses 6 pursues a light path as if the light is radiated from the focal point F on which the virtual image I is set. Then the light is reflected on the reflecting surface 2 and radiated from the light emitting device 1. Therefore, the light from several LED elements 5 can be assumed as if the light radiated form one light source; a lighting direction of the great amount of light from the several lights 5 can be easily controlled with the reflector 3.

### SUMMARY OF THE INVENTION

Because most of LED elements 5 are square in outer shape, an irradiation area which is projected the shape of the LED element 5 also be square in shape. However, the “square” irradiation area has many problems.

That is, most conventional optical instruments are designed as premises for applying light emitting devices which form circular irradiation areas, because conventional incandescent lamps provide circular irradiation areas. When the above light emitting device 1 is applied as a replacement light emitting device for such a conventional optical instrument, the instrument can not give a required performance, due to a difference of irradiation area shape. Furthermore, when the light emitting device 1 is applied as a replacement light emitting device for general lighting, users who are accustomed to the light from the conventional light emitting devices which provide circular irradiation areas feel uncomfortable to the square irradiation area.

The present invention is invented in view of the above-described problems of the conventional art. Accordingly, a main subject of the present invention is to provide a light emitting device which easily controls irradiation directions of large amount of light from several LED elements with a reflector. And the light emitting device can be applied as a replacement light emitting device for a conventional optical instrument without any problems due to its circular irradiation area same as of conventional light emitting device and can be applied for general lighting without giving uncomfortable feeling to users.

According to a first aspect of the present invention, a light emitting device 10A comprises:

a bowl-shaped reflector 12 having a reflecting surface 20 defined by a surface of revolution with a focal point F; and

illuminators 14 arranged inside of the reflector 12 in a radial manner with a central focus on the focal point F;

wherein, each of the illuminators 14 has a LED element 28 being square in planar view and irradiating light to the reflecting surface 20; and a lens 30 arranged between the LED element 28 and the reflecting surface 20, refracting the light radiated from the LED element 28 to the reflecting surface 20, and forming a virtual image I of the LED element 28 with a central focus on the focal point F which arranged behind the LED element 28;

a position of each of the virtual images I from the lens 30 is farther than a position of the focal point F from the lens 30;

when a distance A between the virtual image I and the focal point F and a length of outer circumference B of the LED element 28 being square in planar view are assumed, a value of A divide B (A/B) is not less than 0.08 and not more than 0.42.

According to the light emitting device 10A of the present invention, the position of each of the virtual images I of the LED elements 28 is not defined at the focal point F of the reflecting surface 2 of the conventional light emitting device 1, but defined at farther than the position of the focal point F from the lens 30. Accordingly, a profile of the LED element 28 is projected bleary with formation a circular irradiation area.

But, non-circular irradiating area (an irradiating area which has rounded corner and still gives an appearance of square) and too low center luminance of the irradiation area result from just defining the position of the virtual image I of the LED element 28 farther than the position of the focal point F. Therefore, the value of the distance A [mm] between the virtual image I and the focal point F divide outer circumference B of the LED element 28, in short “A/B”, defined as not less than 0.08 and not more than 0.42.

In case that the value A/B is less than 0.08, the circular irradiating area will not be formed. And in case that the value is more than 0.42, the center luminance of the irradiating area is declined by more than 3% from the center luminance on basis of the light emitting device that the virtual image I of the LED element 28 is positioned at the focal point F.

The position of the focal point F is appropriately defined inside of the reflector 12 and defined on a central axis L of the reflecting surface 20 that is a revolving surface on the basis of mainly size and number of the illuminators located inside of the reflector 12. For example, when the illuminators 14 are substantially big or the number of the illuminators 14 is large, the position of the focal point F is defined to be off from bottom of the reflecting surface 20. And when the illuminators 14 are substantially small or the number of the illuminators 14 is small, the position of the focal point F is defined to be close to the bottom of the reflecting surface 20. When the reflecting surface 20 is an elliptical surface or a paraboloidal surface, the focal point F is defined as a focal point which defines ellipse or parabola.

According to a second aspect of the present invention, a light emitting device 10B comprises:

a bowl-shaped reflector 12 having a reflecting surface 20 defined by a surface of revolution with a focal point F; and

illuminators 14 arranged inside of the reflector 12 in a radial manner with a central focus on the focal point F;

wherein, each of the illuminators 14 has a LED element 28 being square in planar view and irradiating light to the reflecting surface 20; and a lens 30 arranged between the LED element 28 and the reflecting surface 20, refracting the light radiated from the LED element 28 to the reflecting surface 20, and forming a virtual image I of the LED element 28 with a central focus on the focal point F which arranged behind the LED element 28;

the reflecting surface 20 has a large number of tiny reflecting surfaces 26 having a convex curvature surface and being hexagon in planar view;

a position of each of the virtual images I from the lens 30 is farther than a position of the focal point F from the lens 30;

when a distance A between the virtual image I and the focal point F and a length of outer circumference B of the LED element 28 being square in planar view are assumed,

a value of A divide B (A/B) is not less than 0.05 and not more than 0.42.

This light emitting device 10B has a large number of tiny reflecting surfaces 26, so-called “facets”, which has a convex curvature surface and being hexagon in planar view. Luminous flux, which has substantially square in cross sectional, irradiated from each of LED elements 28 is reflected on the tiny reflecting surfaces 26 and diffused to substantially hexagon in shape. Accordingly, the outer shapes of the LED elements 28, which are projected onto the irradiation field, come to circles. The shapes of the irradiation areas can be circles in the state that the distance A between the virtual image I and the focal point F is shorter than that of the light emitting device 10A according to the first aspect of the present invention. When the distance A is short, the irradiation areas tend to be recognized as squares, because the outline of the LED elements 28 becomes clear.

Therefore, according to the second aspect of the present invention, the value that [a distance A between the virtual image I and the focal point F] divided by [a length of outer circumference B of the LED element 28] can be defined as “not less than 0.05”. The value is smaller than that of the light emitting device 10A according to the first aspect of the present invention. “The value is smaller” means that the distance A between the virtual image I and the focal point F is smaller

According to the present invention, a light emitting device whose the irradiation directions of large amount of light from several LED elements can be easily controlled with a reflector can be provided. And the light emitting device can be applied as a replacement light emitting device for conventional optical instrument without any problems due to its circular irradiation area same as of conventional light emitting device and can be applied for general lighting without giving uncomfortable feeling to users.

### BRIEF DESCRIPTION OF THE DRAWINGS

FIG. 1 is a side cross-sectional view showing a light emitting device in accordance with first embodiment and second embodiment of the present invention.

FIG. 2 is an elevation view showing a light emitting device in accordance with the first embodiment of the present invention.

FIG. 3 is an example of an LED element being square in planar view.

FIG. 4 is a schematic view showing different variations on lens.

FIG. 5 is a schematic view showing a reflector having tiny hexagon reflecting surfaces.

FIG. 6 is a cross-sectional view showing a conventional light emitting device.

### DESCRIPTION OF THE PREFERRED EMBODIMENTS

Preferred Embodiments of the present invention are explained with figures as below. Firstly, a light emitting device 10A, which has a large number of tiny reflecting surfaces having a convex curvature surface and being “square” in planar view, is explained as the first embodiment. Then a light emitting device 10B, which has a large number of tiny reflecting surfaces having a convex curvature surface and being “hexagon” in planar view, is explained as the second embodiment. Descriptions in the first embodiment will be incorporated with respect to those common component parts, and points of difference will be mainly described in the second embodiment. In addition, the first embodiment is incorporated for those common component parts in the second embodiment.

### First Embodiment

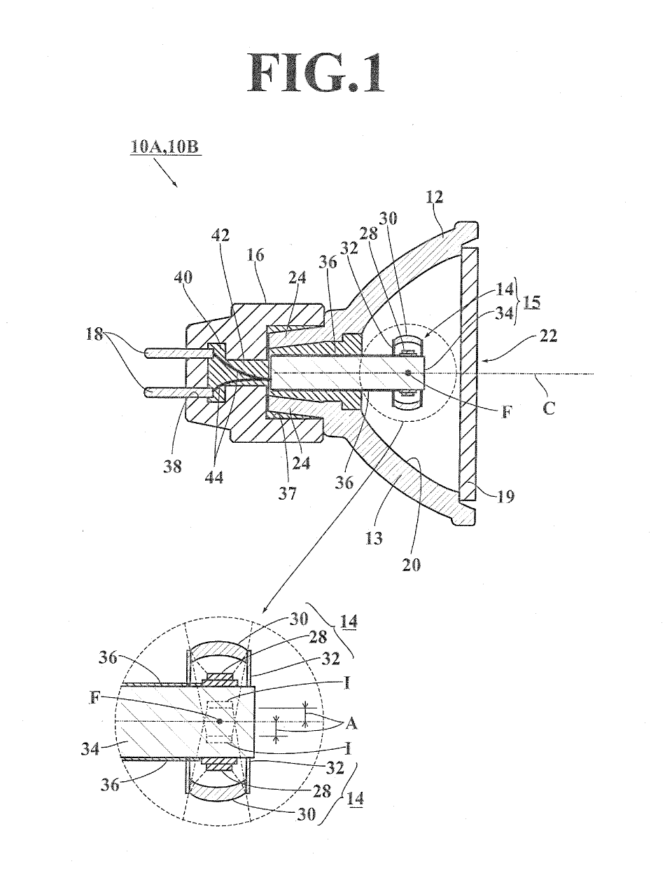

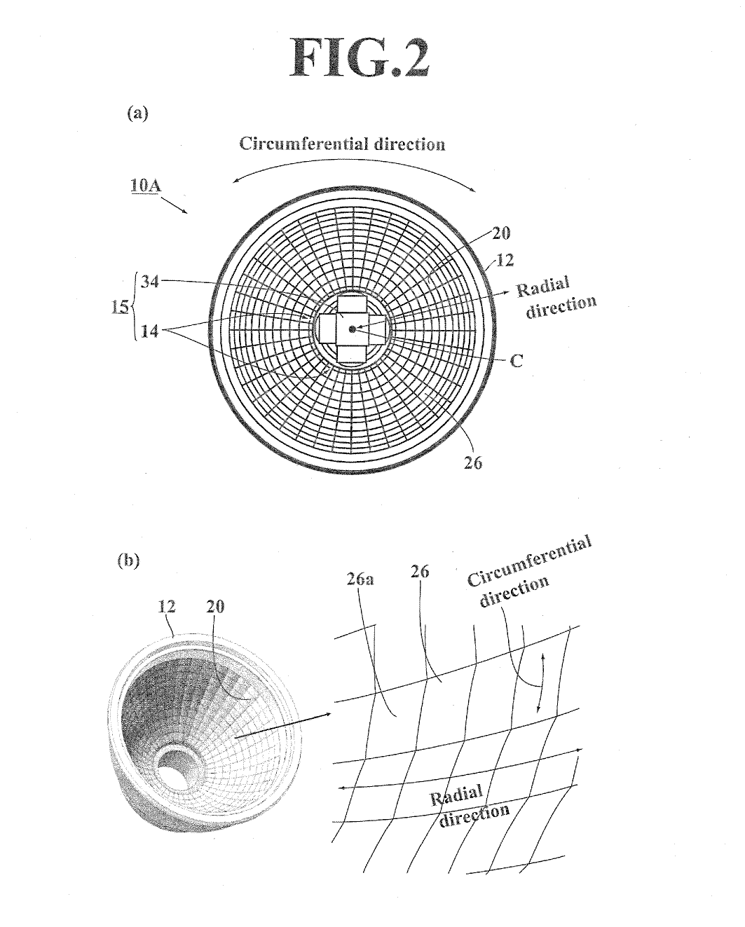

The light emitting device 10A according to the first embodiment comprises, as shown in FIG. 1 and FIG. 2, a concave reflector 12; a light emitting unit 15 having four illuminators 14 and an illuminator holder 34 supporting the illuminators 14; a holder 16; and power feeding terminals 18.

The reflector 12 comprises a reflecting surface 20 formed inside of the reflector 12; a light-emitting opening 22 through which the light reflected on the reflecting surface 20 pass; a central fixing cylindrical portion 24 being inserted into the holder 16. The central fixing cylindrical portion 24 is arranged at bottom center part, which faces to the light-emitting opening 22, of the reflecting surface 20. And a central axis C of the reflecting surface 20 is a straight line that passes through a center of the reflector 12 and is in a direction perpendicular to the light-emitting opening 22.

The reflector 12 is made of glass or aluminum, for example. The reflector 12, which is made of aluminum, has the reflecting surface 20 made by metal evaporation. The reflector 12, which is made of glass, has the reflecting surface 20 made by metal evaporation or made of infrared transmitting glass on a surface of an umbrella-shaped main body of the reflector 12. An illuminator holder 34 of the light emitting device 10A efficiently radiates heat from the LED elements 28, as described below. Consequently, plastics, which are weaker than the glass and the aluminum against heat, can be used for the material of the reflector 12. In this embodiment, the light emitting opening 22 is covered with a front cover 19 made of polycarbonate. The front cover 19, of course, can be made of other transparent material such as glass or the like. Furthermore, the front cover 19 is not essential part for the light emitting device 10A.

The reflecting surface 20 is determined with a revolving surface having a center axis C. A focal point F is on the center axis C inside of the reflector 12. The focal point F is positioned appropriately according to factors such as size of the illuminators arranged inside of the reflector 12 and number of the illuminators, for example. When each illuminator 14 is substantially large or the number of illuminators 14 is large, the focal point F is defined to be off from the bottom of the reflecting surface 20. On the other hand, when each illuminator 14 is substantially small or the number of illuminators 14 is small, the position of the focal point F is defined to be close to the bottom of the reflecting surface 20. When the reflecting surface 20 is an elliptical surface or a paraboloidal surface, the focal point F is defined as a focal point which defines ellipse or parabola.

A large number of tiny reflecting surfaces 26, which are square in planar view and have convex-curvature surfaces, is formed on the reflecting surface 20, see FIG. 2 (b). In this embodiment, as shown in FIG. 2 (a), the reflecting surface 20 is segmented circumferentially by centering the center axis Cin a view from the light-emitting opening 22 to the bottom of the reflector 12. Moreover, the reflecting surface 2 is segmented radially into many multiple-staged square sections with concentric circles, of which diameters are differ from each other. The circles center the center axis C. The tiny reflecting surfaces 26 are formed on surfaces of the square sections.

As shown in FIG. 2 (b), each tiny reflecting surface 26 has convex-curvature surface 26a defined with a radius. The shape of each tiny reflecting surface 26 in planar view is quadrangle, rectangle and trapezoid are also acceptable.

In first embodiment, the tiny reflecting surfaces 26 may be defined by triangles in planar view. Alternatively, the reflecting surface 20 may be defined by a smooth revolving surface without the tiny reflecting surfaces 26.

The light emitting unit 15 has four illuminators 14 and an illuminator holder 34 for supporting the illuminators 14 at desired position, as described above. The number of the illuminators 14 is not limited to four; using two or more illuminators 14 makes same effect of the present invention.

Each illuminator 14 has a LED element 28, a lens 30, and a lens holder 32. In this embodiment, four illuminators 14 are arranged on a tip section of the illuminator holder 34, which is square pole and arranged from bottom of the reflecting surface 20 and along the central axis C. The four illuminators 14 are arranged radially in circumferential direction and at equal intervals by centering the focal point F of the reflecting surface 20.

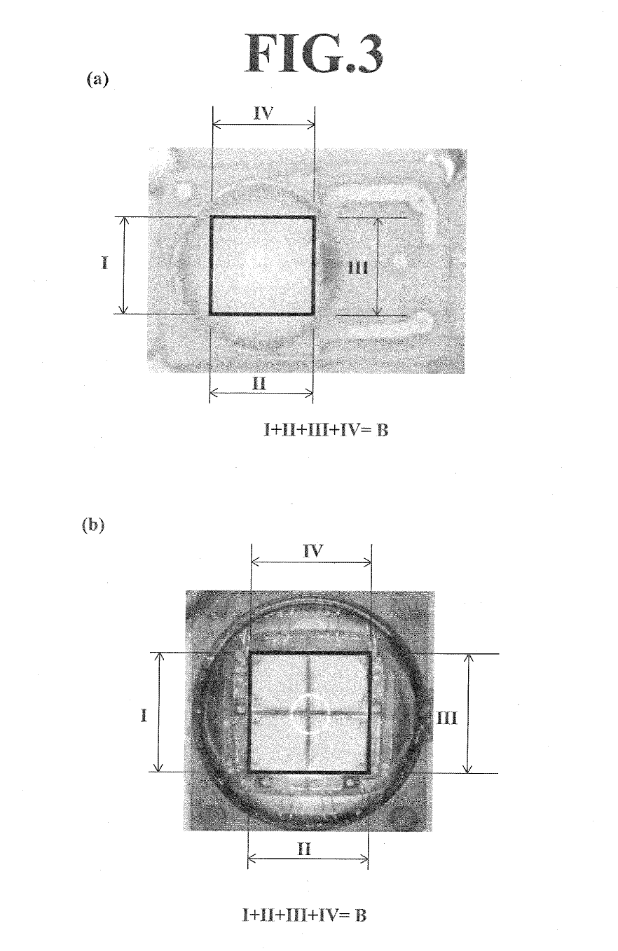

The LED element 28 is an electronic component that emits light by applying electrical current. The light is in 120 degree of irradiating angle; the irradiating angle δ is not limited to 120 degree. Almost all of common LED elements 28 are square in planar view, as illustrated in FIG. 3 by an example. A length of outer edge of the LED element 28, e.g. the total length of I, II, III, and IV in FIG. 3, is defined as “B”. A rectangle, which looks like a square and has 1:1 of aspect ratio, can be used for this embodiment.

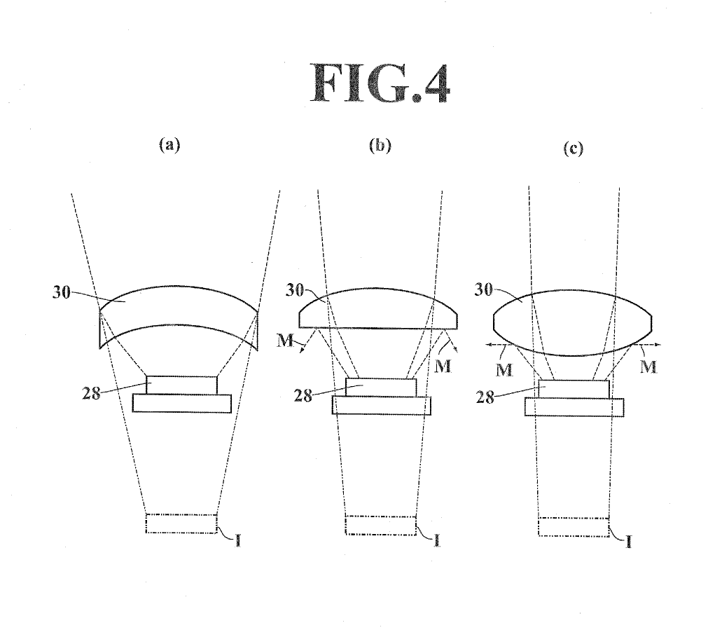

The lens 30 is a convex meniscus lens, which is made of polycarbonate. The lens 30 is arranged between the LED element 28 and the reflecting surface 20, and the lens 30 faces the LED element 28. Of course, other material, which is transparent and can resist heat from the LED element 28, can be used for the lens 30. The “convex meniscus lens” is a lens that has reed-shaped cross-section, and has a convex surface on one side and a concave surface on the other side. (see FIG. 4 (a)). The lens 30 refracts the light from the LED element 28 to the reflecting surface 20, and the lens 30 forms a virtual image I of the LED element 28 behind the LED element 28. A plane-convex lens (FIG. 4 (b)) and a biconvex lens (FIG. 4 (c)) are also used for the lens 30, but the convex meniscus lens is preferable. Because the light M from the LED element 28 to outer edge surface of the plane-convex lens or the biconvex lens will reflect on the surface, when a incidence angle of the light M to the surface is relatively large.

Furthermore, as shown in FIG. 1, a position of each virtual image I of the LED element 28, which is determined by the lens 30 of each illuminator 14, from the lens 30 is farther than a position of the focal point F from the lens 30; a value “A/B” that a distance “A” between the virtual image I and the focal point F is divided by the length of outer edge “B” of the LED element 28 is not less than 0.08 and not more than 0.42. Adjustment of a refractive index of the lens 30 adjusts the position of the virtual image I optically; adjustment of die section size of the illuminator holder 34 adjusts the position physically. Decreasing the section size of the illuminator holder 34 makes the position of the virtual image I farther; increasing the section size of the illuminator holder 34 makes the position of the virtual image I closer. Both adjustment ways, of course, can be applied together.

The lens holder 32 is a cylinder or a prismatic body made of, for example, metal, opaque plastic, or translucency plastic. The lens holder 32 surrounds and encloses the LED element 28. One end of the lens holder 32 is placed on a surface of the illuminator holder 34. The lens 30 is mounted on the other end of the lens holder 32. The lens holder 32 and the illuminator holder 34 may be formed together. When the lens holder 32 is made of metal or opaque plastic, all of the light from the LED element 28 pass through the lens 30. On the other hand, when the lens holder 32 is made of the translucency plastic, most of the light passes though the lens 30, but a part of the light passes through the lens holder 32.

The illuminator holder 34 is, as described above, an aluminum square pole that is arranged from the bottom of the reflecting surface 20 and along the central axis C. Any materials that have high thermal conductivity may be used for the illuminator holder 34. When three illuminators 14 are used, the illuminator holder 34 will be a triangle pole; when five illuminators 14 are used, the illuminator holder 34 will be a pentagonal pole. On end of the illuminator holder 34, the four illuminators 14 are arranged radially in circumferential direction and at equal intervals by centering the focal point F of the reflecting surface 20. The illuminator holder 34, which is made of aluminum with high thermal conductivity, can receive the heat that is generated at the LED element 28 emitting the light. In other words, the illuminator holder 34 not only holds the LED elements 28 and lens 30 but also radiates the heat from the LED elements 28 as a radiator plate. The other end of the illuminator holder 34 is attached to the reflector 12 through the central fixing cylindrical portion 24 with silicon adhesive, for example. Details of attaching instruction are described below.

Power feeding lines 36 for feeding to the LED elements 28 are arranged on four surfaces of the illuminator holder 34 (see FIG. 1). The LED elements 28 receive power through the power feeing lines 36. In this embodiment, the illuminator holder 34, which is made of aluminum, is insulated from the power feeding lines 36. The power feeding lines 36 feed power from the power feeding terminals 18 through lead wires 44. Alternatively, the LED elements 28 may receive power from the lead wires 44 directly.

The holder 16 has a substantially cylindrical body made of heat resistant material such as ceramics. A reflector fixing recess 37 where the central fixing cylindrical portion 24 of the reflector 12 is attached is formed on one end of the holder 16; power feeding terminal fixing holes 38 for fixing the power feeding terminals 18 and a lead wire through hole 40 through which the lead wires 44 pass are formed on the other end of the holder 16. A communication hole 42 is arranged to communicate the reflector fixing recess 37 with the lead wire through hole 40. The lead wires 44 are connected to the power feeding lines 36 on the surfaces of the illuminator holder 34. Furthermore, the reflector 12 and the power feeding terminals 18 are attached and adhered to the holder 16 with, for example, inorganic adhesive. Alumina-silica (Al2O3-SiO2), alumina (Al2O3), or carborundum (SiC) based inorganic adhesives can be used. When temperature of the LED elements 28 are relatively low, epoxy resin can be used as an adhesive.

The power feeding terminals 18 are for feeding power externally. One end of the lead wire 44 is connected to end of the power feeding terminals 18. The other end of the lead wire 44 is electrically connected to the power feeding line 36 of the illuminator holder 34 through the lead wire through hole 40 and the communication hole 42 of the holder 16.

The light emitting device 10A is, for example, manufactured in accordance with the following procedure. The four illuminators 14 are bonded onto the illuminator holder 34 with the inorganic adhesive or the like, and the LED elements 28 are electrically connected to the power feeding line 36. The power feeding terminals 18 are attached into the other end of the holder 16. Then, the central fixing cylindrical portion 24 is fixed to the holder 16 after electrically connecting the power feeding terminals 18 to the illuminator holder 34 with the lead wire 44.

When the electric power is supplied to the power feeding terminals 18 of the light emitting device 10A, the electric power is supplied to the LED elements 28 through the lead wire 44 and the power feeding line 36 of the illuminator holder 34 with emission of light by the LED elements 28. The light emitted from the LED elements 28 is refracted by the lens 30. A path of the refracted light is substantially same as a path of light irradiated from the virtual image I. The refracted light is reflected on the reflecting surface 20, and the reflected light exits from the light emitting device 10A through the light-emitting opening 22.

As a specific embodiment of the first embodiment of the light emitting device 10A, two types of the light emitting device 10A as shown in Tablel. Table 2 and 3 show how “a shape of the irradiation area”, “brightness at an intersection, which is a center of the irradiation area, of a virtual line made by extending the central axis C of the reflecting surface 20 and the irradiation surface”, and “junction temperature of the LED elements 28” changed by changing the distance “A” between the virtual image I, which was determined by the lens 30 of each illuminator 14, of the LED elements 28 and the focal point F of the reflecting surface 20. The distance “A” changed by changing the section size of the illuminator holder 34 physically. And a distance between the light emitting device 10A and the irradiation field was two meters.

TABLE 1

| | Example 1 | Example 2 |
|---|---|---|
| Outer circumference length [mm] B | 6 | 13 |
| Diameter of light-emitting opening [mm] | 70 | 100 |
| Designed light distribution angle [°] | 20 | 30 |
| Shape of tiny reflecting surfaces | Square | Square |

TABLE 2
Example 1

| Distance | | | | | Junction |
|---|---|---|---|---|---|
| A | Irradiation | Brightness at | Distribution | | temperature |
| [mm] | area shape | center [cd] | angle [°] | A/B | [° C.] |
| 0.0 | Square | 2300 | 20.2 | 0.00 | 91 |
| 0.1 | Square | 2340 | 20.1 | 0.02 | 93 |
| 0.2 | Square | 2370 | 20.0 | 0.03 | 94 |
| 0.3 | Nearly | 2380 | 20.0 | 0.05 | 94 |
| | Square | | | | |
| 0.4 | Nearly | 2380 | 20.1 | 0.07 | 96 |
| | Square | | | | |
| 0.5 | Circle | 2380 | 20.1 | 0.08 | 99 |
| 0.6 | Circle | 2380 | 20.2 | 0.10 | 100 |
| 0.7 | Circle | 2370 | 20.2 | 0.12 | 101 |
| 0.8 | Circle | 2370 | 20.3 | 0.13 | 101 |
| 0.9 | Circle | 2370 | 20.3 | 0.15 | 103 |
| 1.0 | Circle | 2370 | 20.3 | 0.17 | 108 |
| 1.1 | Circle | 2370 | 20.3 | 0.18 | 110 |
| 1.2 | Circle | 2370 | 20.3 | 0.20 | 112 |
| 1.3 | Circle | 2360 | 20.3 | 0.22 | 114 |
| 1.4 | Circle | 2360 | 20.3 | 0.23 | 114 |
| 1.5 | Circle | 2360 | 20.4 | 0.25 | 116 |
| 1.6 | Circle | 2360 | 20.4 | 0.27 | 121 |
| 1.7 | Circle | 2360 | 20.4 | 0.28 | 124 |
| 1.8 | Circle | 2360 | 20.4 | 0.30 | 125 |
| 1.9 | Circle | 2350 | 20.4 | 0.32 | 129 |
| 2.0 | Circle | 2350 | 20.4 | 0.33 | 130 |
| 2.1 | Circle | 2350 | 20.5 | 0.35 | 132 |
| 2.2 | Circle | 2350 | 20.5 | 0.37 | 136 |
| 2.3 | Circle | 2340 | 20.5 | 0.38 | 139 |
| 2.4 | Circle | 2310 | 20.5 | 0.40 | 141 |
| 2.5 | Circle | 2240 | 20.6 | 0.42 | 143 |
| 2.6 | Circle | 2180 | 20.8 | 0.43 | 145 |
| 2.7 | Circle | 2100 | 20.9 | 0.45 | 150 |
| 2.8 | Circle | 2020 | 21.3 | 0.47 | 151 |
| 2.9 | Circle | 1920 | 21.5 | 0.48 | 155 |
| 3.0 | Circle | 1800 | 21.8 | 0.50 | 158 |

TABLE 3
Example 2

| Distance | | | | | Junction |
|---|---|---|---|---|---|
| A | Irradiation | Brightness at | Distribution | | temperature |
| [mm] | area shape | center [cd] | angle [°] | A/B | [° C.] |
| 0.0 | Square | 4930 | 29.9 | 0.00 | 91 |
| 0.2 | Square | 4940 | 29.8 | 0.02 | 93 |
| 0.4 | Square | 4950 | 29.7 | 0.03 | 94 |
| 0.6 | Nearly | 4980 | 29.7 | 0.05 | 96 |
| | Square | | | | |
| 0.8 | Nearly | 4990 | 29.7 | 0.06 | 99 |
| | Square | | | | |
| 1.0 | Circle | 4990 | 29.6 | 0.08 | 102 |
| 1.2 | Circle | 5010 | 29.6 | 0.09 | 103 |
| 1.4 | Circle | 5010 | 29.6 | 0.11 | 104 |
| 1.6 | Circle | 5020 | 29.5 | 0.12 | 108 |
| 1.8 | Circle | 5020 | 29.5 | 0.14 | 110 |
| 2.0 | Circle | 5030 | 29.6 | 0.15 | 112 |
| 2.2 | Circle | 5030 | 29.6 | 0.17 | 113 |
| 2.4 | Circle | 5030 | 29.6 | 0.18 | 114 |
| 2.6 | Circle | 5020 | 29.7 | 0.20 | 117 |
| 2.8 | Circle | 5010 | 29.7 | 0.22 | 118 |
| 3.0 | Circle | 5010 | 29.7 | 0.23 | 119 |
| 3.2 | Circle | 5010 | 29.7 | 0.25 | 123 |
| 3.4 | Circle | 5000 | 29.8 | 0.26 | 124 |
| 3.6 | Circle | 5000 | 29.8 | 0.28 | 127 |
| 3.8 | Circle | 5000 | 29.8 | 0.29 | 130 |
| 4.0 | Circle | 4990 | 29.9 | 0.31 | 132 |
| 4.2 | Circle | 4990 | 29.9 | 0.32 | 134 |
| 4.4 | Circle | 4980 | 30.0 | 0.34 | 136 |
| 4.6 | Circle | 4980 | 30.0 | 0.35 | 139 |
| 4.8 | Circle | 4970 | 30.1 | 0.37 | 141 |
| 5.0 | Circle | 4960 | 30.1 | 0.38 | 143 |
| 5.2 | Circle | 4950 | 30.2 | 0.40 | 145 |
| 5.4 | Circle | 4940 | 30.3 | 0.42 | 148 |
| 5.6 | Circle | 4740 | 30.5 | 0.43 | 151 |
| 5.8 | Circle | 4650 | 31.2 | 0.45 | 155 |
| 6.0 | Circle | 4320 | 32.3 | 0.46 | 158 |

As shown in Table 2 and 3, when the “A/B” value was less than 0.08, the shape of the irradiation area on the irradiation field was “square”. “Square” is the shape of the LED elements 28. And when the “A/B” value was not less than 0.08, the shape of the irradiation area was “circle”.

Furthermore, when the “A/B” value was more than 0.42, the center luminance of the irradiation area was declined by more than 3% from the center luminance on basis of the light emitting device that the virtual image I of the LED element 28 was positioned at the focal point F, that means “A=0”. “More than 3%” of decline is unacceptable generally. Accordingly, adjusting the “A/B” value not more than 0.42 makes the center luminance of the irradiation area an acceptable level.

The junction temperature was lower than 150° C. as the upper limit, when the “A/B” value was not less than 0.08 and not more than 0.42. A light distribution angle of the light emitting device 10A did not change very much, when the value of the distance “A” changed. The light distribution angle was approximately design angle, which was 20° in the example 1 and was 30° in the example 2.

### Second Embodiment

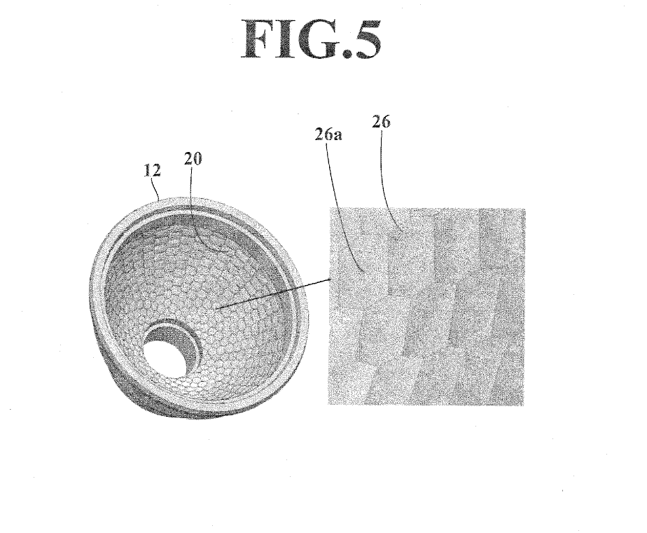

In the same manner as the first embodiment, the light emitting device 10B in the second embodiment comprises a concave reflector 12; a light emitting unit 15 having four illuminators 14 and an illuminator holder 34 supporting the illuminators 14; a holder 16; and power feeding terminals 18. The light emitting device 10B has some differences from the light emitting device 10A as follows; (1) the shapes of the tiny reflecting surfaces 26 of the reflecting surface of the reflector 12 are, as shown in FIG. 5, hexagon in planar view; (2) the value “A/B” that a distance “A” between the virtual image I and the focal point F is divided by the length of outer edge “B” of the LED element 28 is not less than 0.05 and not more than 0.42.

As a specific embodiment of the second embodiment of the light emitting device 10B, two types of the light emitting device 10B as shown in Table4. Table 5 and 6 show how “a shape of the irradiation area”, “brightness at an intersection, which is a center of the irradiation area, of a virtual line made by extending the central axis C of the reflecting surface 20 and the irradiation surface”, and “junction temperature of the LED elements 28” changed by changing the distance “A” between the virtual image I, which was determined by the lens 30 of each illuminator 14, of the LED elements 28 and the focal point F of the reflecting surface 20. The distance “A” was changed by changing the section size of the illuminator holder 34 physically. And a distance between the light emitting device 10B and the irradiation area was two meters.

TABLE 4

| | Example 3 | Example 4 |
|---|---|---|
| Outer circumference length [mm] B | 6 | 13 |
| Diameter of light-emitting opening [mm] | 70 | 100 |
| Designed light distribution angle [°] | 20 | 30 |
| Shape of tiny reflecting surfaces | Hexagon | Hexagon |

TABLE 5
Example 3

| Distance | | | | | Junction |
|---|---|---|---|---|---|
| A | Irradiation | Brightness at | Distribution | | temperature |
| [mm] | area shape | center [cd] | angle [°] | A/B | [° C.] |
| 0.0 | Square | 2270 | 21.0 | 0.00 | 90 |
| 0.1 | Square | 2270 | 20.9 | 0.02 | 93 |
| 0.2 | Nearly | 2290 | 20.8 | 0.03 | 94 |
| | Square | | | | |
| 0.3 | Circle | 2300 | 20.7 | 0.05 | 95 |
| 0.4 | Circle | 2310 | 20.7 | 0.07 | 96 |
| 0.5 | Circle | 2310 | 20.6 | 0.08 | 98 |
| 0.6 | Circle | 2310 | 20.5 | 0.10 | 100 |
| 0.7 | Circle | 2310 | 20.5 | 0.12 | 101 |
| 0.8 | Circle | 2310 | 20.5 | 0.13 | 102 |
| 0.9 | Circle | 2310 | 20.5 | 0.15 | 103 |
| 1.0 | Circle | 2300 | 20.5 | 0.17 | 106 |
| 1.1 | Circle | 2300 | 20.6 | 0.18 | 109 |
| 1.2 | Circle | 2300 | 20.6 | 0.20 | 110 |
| 1.3 | Circle | 2300 | 20.6 | 0.22 | 113 |
| 1.4 | Circle | 2290 | 20.7 | 0.23 | 116 |
| 1.5 | Circle | 2290 | 20.7 | 0.25 | 116 |
| 1.6 | Circle | 2290 | 20.9 | 0.27 | 119 |
| 1.7 | Circle | 2290 | 21.0 | 0.28 | 123 |
| 1.8 | Circle | 2280 | 21.0 | 0.30 | 126 |
| 1.9 | Circle | 2280 | 21.2 | 0.32 | 129 |
| 2.0 | Circle | 2280 | 21.3 | 0.33 | 131 |
| 2.1 | Circle | 2280 | 21.3 | 0.35 | 132 |
| 2.2 | Circle | 2280 | 21.3 | 0.37 | 135 |
| 2.3 | Circle | 2270 | 21.3 | 0.38 | 136 |
| 2.4 | Circle | 2250 | 21.4 | 0.40 | 142 |
| 2.5 | Circle | 2220 | 21.5 | 0.42 | 145 |
| 2.6 | Circle | 2100 | 21.5 | 0.43 | 149 |
| 2.7 | Circle | 2030 | 21.9 | 0.45 | 150 |
| 2.8 | Circle | 2000 | 22.5 | 0.47 | 151 |
| 2.9 | Circle | 1920 | 22.9 | 0.48 | 155 |
| 3.0 | Circle | 1820 | 23.5 | 0.50 | 158 |

TABLE 6
Example 4

| Distance | | | | | Junction |
|---|---|---|---|---|---|
| A | Irradiation | Brightness | Distribution | | temperature |
| [mm] | area shape | at center [cd] | angle [°] | A/B | [° C.] |
| 0.0 | Square | 4830 | 30.5 | 0.00 | 92 |
| 0.2 | Square | 4830 | 30.5 | 0.02 | 94 |
| 0.4 | Nearly | 4850 | 30.4 | 0.03 | 95 |
| | Square | | | | |
| 0.6 | Circle | 4880 | 30.4 | 0.05 | 96 |
| 0.8 | Circle | 4900 | 30.3 | 0.06 | 98 |
| 1.0 | Circle | 4920 | 30.3 | 0.08 | 100 |
| 1.2 | Circle | 4930 | 30.2 | 0.09 | 102 |
| 1.4 | Circle | 4930 | 30.2 | 0.11 | 104 |
| 1.6 | Circle | 4950 | 30.2 | 0.12 | 105 |
| 1.8 | Circle | 4960 | 30.1 | 0.14 | 107 |
| 2.0 | Circle | 4970 | 30.1 | 0.15 | 111 |
| 2.2 | Circle | 4980 | 30.2 | 0.17 | 113 |
| 2.4 | Circle | 4980 | 30.3 | 0.18 | 114 |
| 2.6 | Circle | 4980 | 30.3 | 0.20 | 116 |
| 2.8 | Circle | 4970 | 30.3 | 0.22 | 119 |
| 3.0 | Circle | 4970 | 30.3 | 0.23 | 120 |
| 3.2 | Circle | 4970 | 30.4 | 0.25 | 123 |
| 3.4 | Circle | 4960 | 30.4 | 0.26 | 125 |
| 3.6 | Circle | 4950 | 30.5 | 0.28 | 126 |
| 3.8 | Circle | 4950 | 30.5 | 0.29 | 130 |
| 4.0 | Circle | 4950 | 30.5 | 0.31 | 133 |
| 4.2 | Circle | 4940 | 30.6 | 0.32 | 134 |
| 4.4 | Circle | 4930 | 30.6 | 0.34 | 135 |
| 4.6 | Circle | 4930 | 30.7 | 0.35 | 140 |
| 4.8 | Circle | 4930 | 30.7 | 0.37 | 142 |
| 5.0 | Circle | 4920 | 30.8 | 0.38 | 143 |
| 5.2 | Circle | 4870 | 30.9 | 0.40 | 146 |
| 5.4 | Circle | 4810 | 31.1 | 0.42 | 149 |
| 5.6 | Circle | 4650 | 32.2 | 0.43 | 153 |
| 5.8 | Circle | 4400 | 32.9 | 0.45 | 155 |
| 6.0 | Circle | 4260 | 33.8 | 0.46 | 158 |

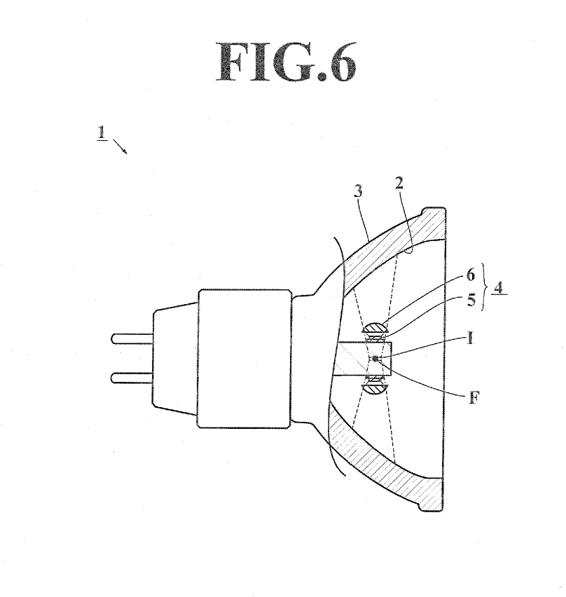

As shown in FIG. 5 and FIG. 6, when the value “A/B” is less than 0.05, the shape of the irradiation area on the irradiation field was “square”. And when the “A/B” value was not less than 0.05, the shape of the irradiation area was “circle”.

Furthermore, when the “A/B” value was more than 0.42, the center luminance of the irradiation area was declined by more than 3% from the center luminance on basis of the light emitting device that the virtual image I of the LED element 28 was positioned at the focal point F, that means “A=0”. “More than 3%” of decline is unacceptable generally. Accordingly, adjusting the “A/B” value not more than 0.42 makes the center luminance of the irradiation area at an acceptable level.

The junction temperature was lower than 150° C. as the upper limit, when the “A/B” value was not less than 0.05 and not more than 0.42. A light distribution angle of the light emitting device 10B did not change very much, when the value of the distance “A” changed. The light distribution angle was approximately design angle, which was 20° in the example 3 and was 30° in the example 4.

According to the first and second embodiment, a light emitting device whose the irradiation directions of large amount of light from several LED elements can be easily controlled with a reflector can be provided. And the light emitting device can be applied as a replacement light emitting device for conventional optical instrument without any problems due to its circular irradiation area same as of conventional light emitting device and can be applied for general lighting without giving uncomfortable feeling to users.

Although the invention has been described in its preferred form with a certain degree of particularity, it is understood that the present disclosure of the preferred form has been changed in the details of construction and the combination and arrangement of parts may be resorted to without departing from the spirit and scope of the invention as hereinafter claimed.

The disclosure of Japanese Patent Application No. 2009-233262 filed Oct. 7, 2009 including specification, drawings and claims is incorporated herein by reference in its entirety.

What is claimed is:

1. a light emitting device comprising:
a bowl-shaped reflector having a reflecting surface defined by a surface of revolution with a focal point; and
illuminators arranged inside of the reflector in a radial manner with a central focus on the focal point;
wherein, each of the illuminators has a LED element being square in planar view and irradiating light to the reflecting surface; and a lens arranged between the LED element and the reflecting surface, refracting the light radiated from the LED element to the reflecting surface, and forming a virtual image of the LED element with a central focus on the focal point which arranged behind the LED element;
a position of each of the virtual images from the lens is farther than a position of the focal point from the lens;
when a distance A between the virtual image and the focal point and a length of outer circumference B of the LED element being square in planar view are assumed, a value of A divide B (AM) is not less than 0.08 and not more than 0.42.

2. a light emitting device comprising:
a bowl-shaped reflector having a reflecting surface defined by a surface of revolution with a focal point; and
illuminators arranged inside of the reflector in a radial manner with a central focus on the focal point;
wherein, each of the illuminators has a LED element being square in planar view and irradiating light to the reflecting surface; and a lens arranged between the LED element and the reflecting surface, refracting the light radiated from the LED element to the reflecting surface, and forming a virtual image of the LED element with a central focus on the focal point which arranged behind the LED element;
the reflecting surface has a large number of tiny reflecting surfaces having a convex curvature surface and being hexagon in planar view;
a position of each of the virtual images from the lens is farther than a position of the focal point F from the lens;
when a distance A between the virtual image and the focal point and a length of outer circumference B of the LED element being square in planar view are assumed, a value of A divide B (A/B) is not less than 0.05 and not more than 0.42.
